(19) United States
(12) Patent Application Publication
(10) Pub. No.: US 2006/0012609 A1
(43) Pub. Date: Jan. 19, 2006

(54) Methods and system for processing image data

(76) Inventor: Bradley R. Larson, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/044,546

(22) Filed: Jan. 26, 2005

Related U.S. Application Data
(60) Provisional application No. 60/588,081, filed on Jul. 15, 2004.

(51) Int. Cl. G09G 5/02

(52) U.S. Cl. 345/600

(57) ABSTRACT

Representative embodiments provide for a method including providing image data defining a plurality of pixels, each pixel defined by one or more color layers, and each color layer defined by one or more data bits. The method also includes selecting two or more of the plurality of pixels, and translating the one or more data bits defining each of the one or more color layers of the two or more selected pixels in accordance with a predefined function to define a single translated pixel. The method also includes rendering an image including the single translated pixel.

### RELATED APPLICATIONS

This application claims priority of U.S. Provisional Application Ser. No. 60/588,081 of Bradley R. Larson for METHODS AND SYSTEM FOR PROCESSING IMAGE DATA, filed Jul. 15, 2004.

### BACKGROUND

Computer systems and associated devices are commonly used to receive, store, generate, manipulate and display (or playback) various kinds of image files. Examples of such image files include digital photographs and movies, computer-aided drafting (CAD) documents, computer-generated images and numerous other textual and graphical entities. It is also known to encode such image files using different file formats (e.g., MPEG, TIFF, Bitmap, JPEG, etc.), typically consisting of relatively vast amounts of digital data (i.e., binary bits arranged as bytes or digital words).

Generally, the digital data of such an image file defines the various graphical objects represented therein as a matrix or array of pixels, or individually colored dots. Each pixel represents the smallest individual portion of an overall image for a given degree of image resolution such as, for example, 600-by-600 dots per inch. It is generally well known that increasing the image resolution—that is, increasing the total number of pixels used to represent an image—results in increased image sharpness and definition.

However, such an increase in the overall number of pixels is usually accompanied by a generally undesirable increase in the number of data bits required to encode the overall image file, as well as increasing the amount of computer-readable storage space (e.g., memory, magnetic media, etc.) required to store such an image file. Furthermore, it is generally difficult to devise systems and techniques for handling individual image files that include pixels of plural (differing) resolutions.

Therefore, it is desirable to provide methods and systems that provide the advantages of increased image resolution without substantially increasing the overall image file size, while reliably handling the associated image file data.

### SUMMARY

Embodiments of the invention provide a method, wherein the method includes the step of providing image data defining a plurality of pixels. Each pixel is defined by one or more color layers, wherein each color layer is defined by one or more data bits. The method also includes the steps of selecting two or more of the plurality of pixels, and translating the one or more data bits that define each of the one or more color layers of the two or more selected pixels, in accordance with a predefined function, to define a single translated pixel. The method further includes the step of rendering an image including the single translated pixel.

Embodiments of the invention also provide another method, the method including the step of providing image data defining a plurality of pixels. Each of the pixels is defined by one or more color layers, wherein each color layer is defined by a plurality of data bits. The method also includes the steps of selecting one of the plurality of pixels, and translating the plurality of data bits that define each of the one or more color layers of the selected pixel, in accordance with a predefined function, so as to define two or more translated pixels. Furthermore, the method includes the step of rendering an image including the two or more translated pixels.

Embodiments of the invention further provide a computer-readable storage media including a program code, wherein the program code is configured to cause a processor to receive image data defining a plurality of pixels, and wherein each pixel defines one of a first resolution or a second resolution. The program code is further configured to cause the processor to selectively translate data defining two or more pixels of the first resolution of the image data, so as to derive data defining a first number of translated pixels of the second resolution, wherein the first number of translated pixels collectively define a first type image window. Furthermore, the program code is configured to cause the processor to selectively translate data defining two or more pixels of the second resolution of the image data, so as to derive data defining a second number of translated pixels of the first resolution, wherein the second number of translated pixels collectively define a second type image window. Further still, the program code is configured to cause the processor to combine the data of the image windows of the first type and the second type to define translated image data.

These and other aspects and embodiments will now be described in detail with reference to the accompanying drawings, wherein:

### DESCRIPTION OF THE DRAWINGS

FIG. 1 is block schematic view, depicting an imaging arrangement known in the art.

FIG. 2 is block schematic view, depicting an imaging arrangement in accordance with one embodiment of the present invention.

FIG. 3 is a block schematic view, depicting an imaging arrangement in accordance with another embodiment of the present invention.

FIG. 4 is a block schematic view, depicting an imaging arrangement in accordance with yet another embodiment of the present invention.

FIG. 5 is block schematic view, depicting a method in accordance with the present invention.

FIG. 5A is a block schematic view, depicting an imaging arrangement in accordance with the method of FIG. 5.

FIG. 6 is a block schematic view, depicting another method in accordance with the present invention.

FIG. 6A is a block schematic view, depicting an imaging arrangement in accordance with the method of FIG. 6.

FIG. 7 is a flowchart, depicting still another method in accordance with the present invention.

### DETAILED DESCRIPTION

In representative embodiments, the present teachings provide methods and systems for particularly defining and translating image data representing, for example, graphical objects, electronic photographs, electronic moving images (movies), etc. More specifically, the methods and system of the present teachings are generally directed to defining and translating the binary information (i.e., data bits) that represent such images. A number of embodiments of the present invention are directed to a relative increase in the image resolution of a portion of an image (e.g., pixels translated from 600-by-600 to 2400-by-1200 dots per inch) that is defined by one or more digital words, wherein the overall quantity of digital data (i.e., total bit count) of the digital word(s) is not increased. Similarly, other embodiments of the present invention are typically directed to a relative decrease in the image resolution of an image portion (e.g., pixels translated from 2400-by-1200 to 600-by-600 dots per inch) that is defined by one or more digital words, wherein the overall representative data quantity (i.e., word size) is kept substantially constant.

While numerous embodiments are described hereinafter in terms of specific image resolutions (e.g., 600-by-600 dots per inch, etc.), it is to be understood that the methods and systems of the present invention are intended to be used with digital image data of differing image resolutions. This is true with respect to either or both of the image resolution of original image data or the translated image data resulting from the various methods of the present invention. Similarly, embodiments of the present invention are described hereinafter in the context of pixels defined by three color layers—typically cyan, magenta and yellow. However, it is to be understood that other embodiments of the methods and systems of the present invention can be used in conjunction with image data defining pixels with other numbers of color layers and/or respective colors of those color layers.

While the methods and systems of embodiments of the present invention are typically described in the context of the edgewise or perimeter portion of a graphical object, it is to be understood that the other regions of an image can also be similarly manipulated as required and/or desired. Furthermore, the methods and systems of embodiments of the present invention are generally directed to translating selective portions of an image data file so that a substantially homogeneous image resolution is realized for all of the pixels of the image data file. In this way, certain embodiments of the present invention provide translated or partially translated image data that is readily imaged or rendered by apparatus and system that otherwise cannot handle mixed-resolution image data.

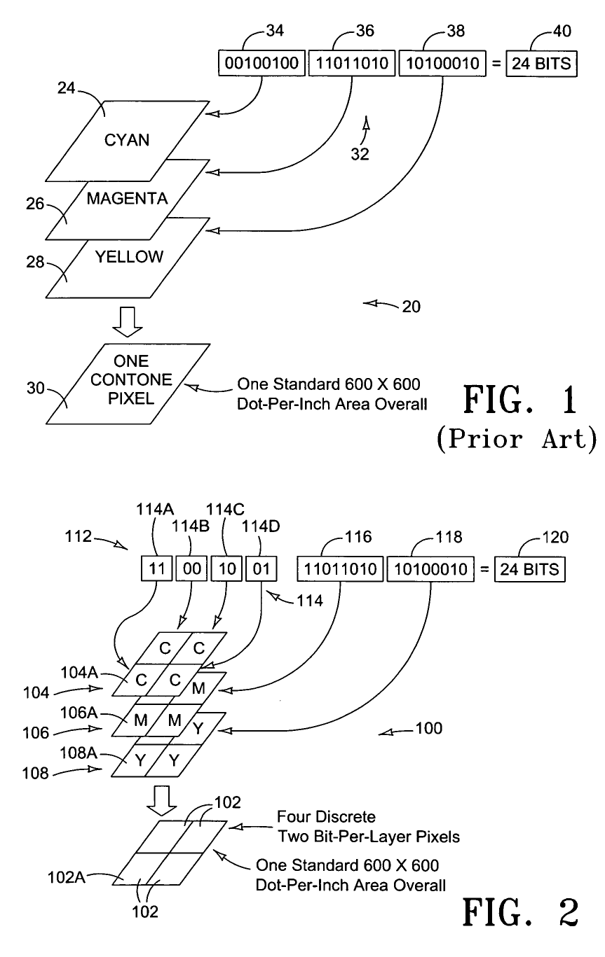

Turning now to FIG. 1, a block schematic view depicts an imaging arrangement 20 according to the known art. The arrangement 20 is defined by three separate color layers 22. The three color layers 22 include a cyan color layer 24, a magenta color layer 26, and a yellow color layer 28. One of skill in the imaging arts can appreciate that each of the respective color layers 24-28 can be provided in a number of known ways, such as, for example, through the use of suitably controlled inkjet mechanism or a color display screen (not shown, respectively). In this way, the three color layers 24-28 chromatically combine when mutually provided to define a pixel 30. As provided herein, the pixel 30 is also known as a contone (i.e., continuous-tone) pixel of substantially one perceptible color or hue. As depicted in FIG. 1, the pixel 30 defines an image resolution of 600-by-600 dots per inch.

As further depicted in FIG. 1, each of the respective color layers 24, 26 and 28 includes an intensity, or color saturation level, that is defined by eight binary data bits, or a single data byte, 32. Thus, the color layers 24, 26 and 28 are respectively defined by data bytes 34, 36 and 38. The pixel 30 is therefore completely defined by the overall combination of the data bytes 34, 36 and 38 as a single twenty-four bit data word 40. A further result of this eight-bits (one byte) per color layer definition is that the intensity or color saturation of each color layer 24-28 can be independently defined by any one of two hundred fifty-six discrete values, including zero. Thus, each of the pixels 30 is also referred to herein as an eight bit-per-layer pixel. One of skill in the imaging arts can also appreciate that a plurality of such pixels 30 are typically defined by an image data file (not shown) so as to electronically provide, for example, a still image, a motion video, etc. The arrangement 20 of FIG. 1 is intended to convey imaging concepts that are generally fundamental to an understanding of the instant invention.

FIG. 2 is a block schematic view depicting an imaging arrangement 100 in accordance with one embodiment of the instant invention. The arrangement 100 includes (i.e., defines) a total of four pixels 102. Each of the pixels 102 occupies an image area defining an image resolution of 1200-by-1200 dots per inch. As depicted in FIG. 2, the four pixels 102 are mutually arranged to occupy an overall image area defining a resolution of 600-by-600 dots per inch. Thus, the four pixels 102 of FIG. 2 represent an effective doubling of image resolution relative to that of the pixel 30 of FIG. 1.

Each of the pixels 102 is comprised of (defined by) a cyan color layer 104, a magenta color layer 106 and a yellow color layer 108, wherein the intensity (i.e., color saturation) of each of the color layers 104-108 for a given pixel 102 is defined by two binary data bits 112. To clarify, exemplary pixel 102A is comprised of a cyan color layer 104A, a magenta color layer 106A, and a yellow color layer 108A, wherein the color layers 104A-108A chromatically combine (when suitably rendered, or imaged) to substantially define a single final color or hue. Furthermore, the intensity of the cyan color layer 104A of exemplary pixel 102A is defined by a binary data bit pair 114A. In turn, each of the remaining pixels 102 is partially defined by a corresponding portion of the cyan color layer 104 as respectively defined by data bit pairs 114B-114D.

Thus, the complete cyan color layer 104 is defined by a single eight-bit data byte 114. Similarly, the magenta color layer 106 and the yellow color layer 108 are respectively defined by eight-bit data bytes 116 and 118, wherein each byte is considered as four, two-bit data pairs. The data bytes 104-108 are combined to define a single twenty-four bit data word 120. In this way, the data word 120 includes the image data required to completely represent the four discrete pixels 102 as depicted in FIG. 2. Each of the pixels 102 is also referred to herein as a two bit-per-layer pixel. Furthermore, the intensity of each of the color layers 104-108 defining a given pixel 102 can be independently defined as any one of four discrete values, including zero, by virtue of the binary two-bit definition (i.e., intensity value) of each color layer 104-108.

As described above, the pixels 102 of FIG. 2 represent a doubling of image resolution, relative to the known pixel 30 of FIG. 1, without an increase in the total amount of image data (i.e., a twenty-four bit word) required to define an image of given overall dimensions. In a further comparison between the pixel 30 of FIG. 1 and the pixels 102 of FIG. 2, the same overall data bit count (twenty-four bits total per pixel) is generally reconfigured so as to shift emphasis away from color resolution and toward increased image resolution. Also, it is to be understood that the pixels 102 can be imaged (formed, or provided) by any suitable technique such as, for example, inkjet or other media deposition on sheet media, imaging by way of an electronic display screen, etc., or stored to computer-readable media for later use (not shown, respectively). Such an increase in image resolution can be desirable, for example, to enhance the sharpness or definition of an edgewise or perimeter portion of an object represented within an image data file.

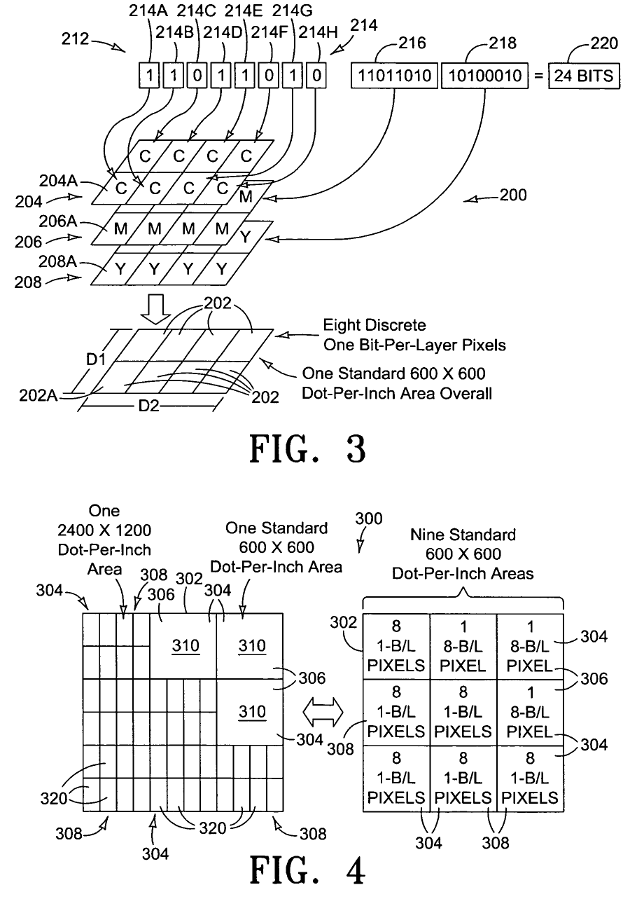

FIG. 3 is a block schematic view depicting an imaging arrangement 200 in accordance with another embodiment of the instant invention. The arrangement 200 includes (i.e., defines) a total of eight pixels 202. Each of the pixels 202 occupies an image area that defines an image resolution of 2400-by-1200 dots per inch. As also depicted in FIG. 3, the eight pixels 202 are mutually arranged so as to occupy an overall image area defining a resolution of 600-by-600 dots per inch. Thus, the imaging arrangement 200 of FIG. 3 represents an effective doubling of image resolution along a first dimension D1, and an effective quadrupling of image resolution along a second dimension D2, relative to that of the pixel 30 of FIG. 1.

Each of the pixels 202 of FIG. 3 is comprised of (defined by) a cyan color layer 204, a magenta color layer 206, and a yellow color layer 208, substantially as defined above in regard to the color layers 104-108 of the arrangement 100 of FIG. 2, respectively, wherein the intensity (i.e., color saturation) of each of the color layers 204-208 for a given pixel 202 is defined a single binary data bit 212. To clarify, an exemplary pixel 202A is comprised of a cyan color layer 204A, a magenta color layer 206A, and a yellow color layer 208A, which chromatically combine when the pixel 202A is suitably rendered or imaged to define a single color or hue.

Furthermore, the intensity of the cyan color layer 204A of exemplary pixel 202A is defined by a binary data bit 214A. In turn, each of the remaining pixels 202 is partially defined by a corresponding portion of the cyan color layer 204 as respectively defined by data bits 214B-214H. As a result of this single-bit intensity definition, each of the color layers 204-208 of each pixel 202 can be defined by only two respective states or conditions: the respective color 204-208 is present in some predefined intensity, or it is substantially absent altogether (i.e., “one” or “zero”).

Therefore, the full cyan color layer 204 is defined by a single eight-bit data byte 214. Similarly, the magenta color layer 206 and the yellow color layer 208 are respectively defined by eight-bit data bytes 216 and 218. The data bytes 204-208 are combined to define a single twenty-four bit data word 220. Thus, the data word 220 includes all of the image data required to fully represent the eight discrete pixels 202 depicted in FIG. 3. Each of the pixels 202 is also referred to herein as a one bit-per-layer pixel. It is to be understood that the pixels 202 can be imaged (formed, or provided) by any of the suitable techniques described above in regard to the pixels 102 of FIG. 2.

The pixels 102 and 202 of FIGS. 2 and 3 are described above in the context of cyan, magenta and yellow color layers 104-108 and 204-208, respectively. In other embodiments of the present invention (not shown), differing types of two bit-per-layer and one bit-per-layer pixels can be defined and used respectively, including differing numbers of color layers and/or layer-color definitions. For example (not shown), a two bit-per-layer pixel can be defined which includes a black layer in addition to the cyan, magenta and yellow layers described above. Such a four-layer pixel (not shown) can be desirably used in conjunction with, for example, a four-color inkjet printer. Other pixel embodiments can also be used.

FIG. 4 is a block schematic view depicting an imaging arrangement 300 in accordance with still another embodiment of the present invention. The arrangement 300 includes an image window 302. In the interest of understanding, the image window 302 is depicted in FIG. 4 in two different presentation formats, but both image window 302 presentations are comprised of the same image data content. The image window 302 includes, or defines, a three-by-three arrangement of image regions 304. Each of the image regions 304 defines an image resolution of 600-by-600 dots per inch It is to be understood that other image regions (not shown) defining other suitable image resolutions can also be used.

In any case, the image regions 304 of FIG. 4 are each further defined in one of two different ways: as a relatively low-resolution image region 306 comprised of a single eight bit-per-layer pixel 310 (e.g., the pixel 30 of FIG. 1); or as a relatively high-resolution image region 308 comprised of eight discrete one bit-per-layer pixels 320 (e.g., the pixels 202 of FIG. 3). Therefore, as depicted in FIG. 4, the image window 302 includes a total of three, eight bit-per-layer pixels 310, and a total of forty-eight, one bit-per-layer pixels 320, for a grand total of fifty-one pixels overall. Furthermore, it is to be noted that the image window 302 can be completely defined by a total of nine, twenty-four bit (i.e., three byte) data words. In this way, the image window 302 as depicted in FIG. 4 includes a total of six relatively high-resolution image regions 308 and three relatively low-resolution image regions 306. The relatively high-resolution image regions 308 of the image window 302 can be used, for example, to define or represent an edgewise (i.e., perimeter) portion of a graphical object within image data file. The image window 302 is also considered to include mixed-resolution image data.

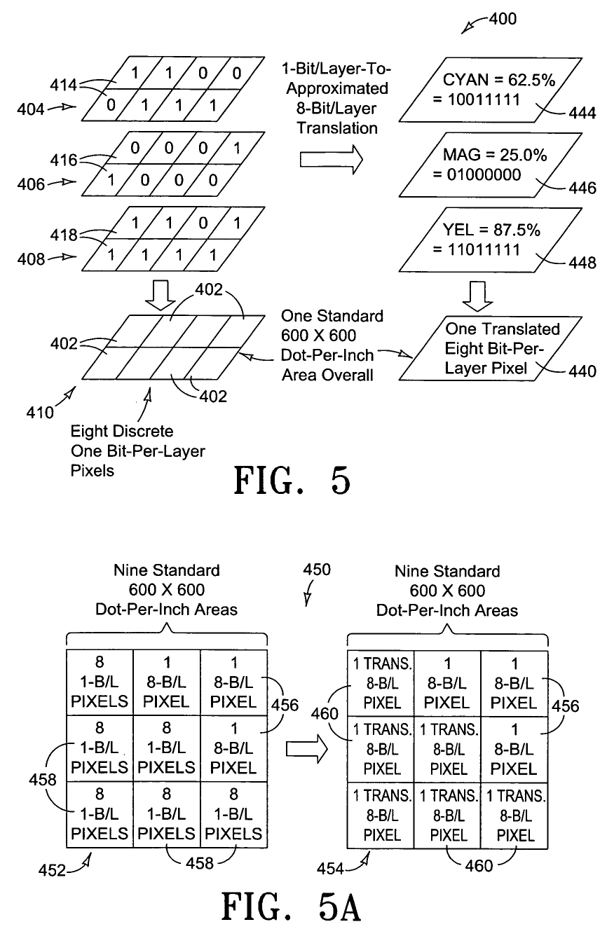

FIG. 5 is a block schematic view, depicting an exemplary method 400 in accordance with embodiments of the present invention. In particular, the exemplary method 400 depicts the translation of a first type of imaging data (i.e., pixels) to a second type of approximated pixel. The exemplary method 400 generally begins with the provision of eight, one bit-per-layer pixels 402. Each of the pixels 402 define an image resolution of 2400-by-1200 dots per inch, and are mutually arranged to define an image region 410 defining an image resolution of 600-by-600 dots per inch. Furthermore, each of the pixels 402 is defined by a cyan color layer 404, a magenta color layer 406, and a yellow color layer 408. Thus, the pixels 402 are substantially equivalent to the pixels 202 of FIG. 3.

As depicted in FIG. 5, each of the color layers 404-408 is defined by a total of eight data bits, wherein each pixel 402 is defined by a corresponding cyan color layer bit 414, a magenta color layer bit 416, and a yellow color layer bit 418. As further depicted in FIG. 5, the cyan color layer 404 is defined by a total of five active (i.e., “one”-status) data bits, and a total of three inactive (i.e., “zero”-status) data bits. In this way, the overall image region 410, which is represented by the eight respective pixels 402, can be considered to have an overall cyan color layer intensity of five-eights, or 62.5%. In such a manner, each of the active (i.e., “one”) data bits is considered to contribute a total cyan color layer 404 intensity of one-eighth (of the maximum possible intensity for that color) to the overall image region 410. Similarly as depicted in FIG. 5, the magenta color layer 406 can be considered to define a two-eighths, or 25.0%, color intensity, while the yellow color layer 408 can be considered to define a seven-eighths, or 87.5%, color intensity to the overall image region 410.

Using the equal-weighting, or summation, approach described above, an embodiment of the exemplary method 400 can be used to define an approximated cyan color layer 444, an approximated magenta color layer 446, and an approximated yellow color layer 448, respectively depicted in FIG. 5. When the approximated color layers 444-448 are suitably rendered or imaged (e.g., by way of an inkjet printer on sheet media or by an electronic color screen display, etc.), the chromatic combination thereof results in a single translated pixel 440 including substantially one homogeneous color or hue. The translated pixel 440 is also referred to herein as a translated eight bit-per-layer pixel. It is to be understood that the particular data bit 414-418 patterns, or values, as depicted in FIG. 5 are exemplary only, and that the exemplary method 400 is usable in conjunction with other particular data bit 414-418 values, thus resulting in other corresponding values for the translated color layers 444-448.

Furthermore, the translation process of exemplary method 400 is described above in terms of the generally simple summation of equally-weighted data bits 414-418 defining each of the color layers 404-408, so as to respectively define translated color layers 444-448 of the translated pixel 440. It is to be understood that other suitable techniques (not shown) can also be used within the context of method 400 such as, for example:
unequally weighting particular ones of the data bits 414-418 defining the respective color layers 404-408, and then summing their values to respectively define each of the translated color layers 444-448;
summing equally-weighted data bits 414-418 defining each color layer 404-408, followed by averaging the sum values for each of the color layers 404-408, and then defining each of the translated color layers 444-448 using a common average value;
translation of particular ones of the data bits 414-418 in accordance with a predefined look-up table so as to define each of the translated color layers 444-448;
Other techniques as suitable and/or desired.

FIG. 5A is a block schematic view depicting an imaging arrangement 450 in accordance with the exemplary method 400 of FIG. 5. The imaging arrangement 450 includes an image window 452. The image window 452 includes a three-by-three, mixed-resolution arrangement including a total of six high-resolution image regions 458, and a total of three low-resolution image regions 456. Therein, each high-resolution image region 458 is defined by a total of eight, one bit-per-layer pixels (not shown in FIG. 5A, see the pixels 402 of FIG. 5). Also, each low-resolution image region 456 of FIG. 5A is defined by a single eight bit-per-layer pixel (not shown in FIG. 5A, see the pixels 310 of FIG. 4).

It is then assumed that the exemplary method 400 of FIG. 5, substantially as described above, is applied to the pixels (not shown) of the six high-resolution image regions 458 of the image window 452. As a result thereof, a translated image window 454 is defined. The translated image window 454 includes a total of six image regions 460—directly corresponding to the six high-resolution image regions 458 of the image window 452—and the total of three low-resolution image regions 456 as originally present in the image window 452. Each of the image regions 460 of the translated image window 454 includes a single, respectively defined, translated eight bit-per-layer pixel that is substantially equal to the translated pixel 440 of FIG. 5.

Therefore, both the image window 452 and the translated image window 454 can be respectively defined by nine, twenty-four data bit words. Thus, equal quantities of binary data can be used to define each image window 452 and the respective translated image window 454. However, by virtue of the exemplary method 400 of FIG. 5, the translated image window 454 comprises nine equal-resolution image regions, as compared to the mixed-resolution image regions (458 and 456) of the image window 452. Such a translation of image data can be desirable, for example, to facilitate the rendering of images on imaging apparatus (e.g., printers, electronic displays, etc.) that otherwise cannot readily, if at all, handle the type of mixed-resolution image data that defines the image window 452. Furthermore, such a translation of image data can be used, for example, with those devices and apparatus that are operative only with eight bit-per-layer pixels (as typically configured to define a resolution of 600-by-600 dots per inch).

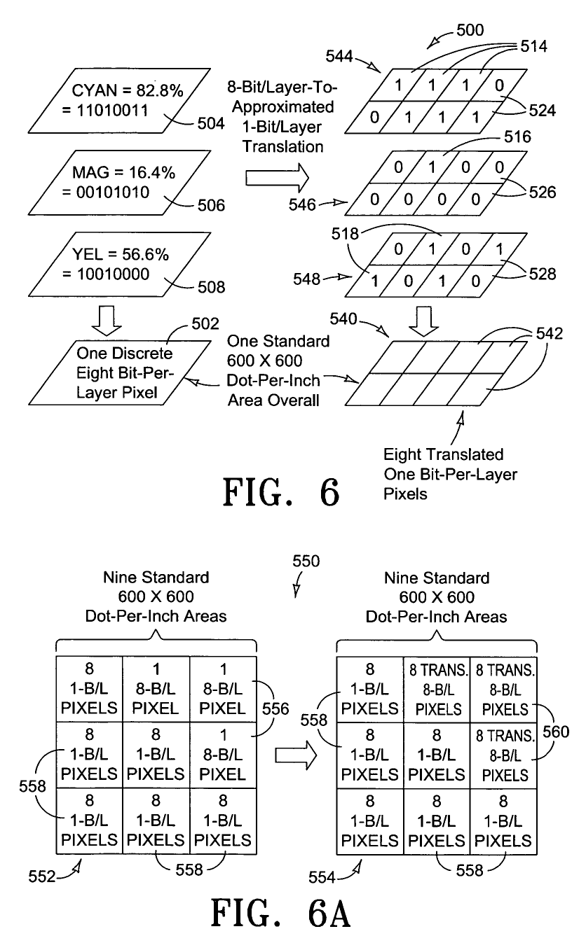

FIG. 6 is a block schematic view depicting an exemplary method 500, in accordance with embodiments of the present invention. More specifically, the method 500 depicts the translation of a first type of pixel (that is, the data representative thereof) to a plurality of second type translated pixels. The exemplary method 500 typically begins with the provision of imaging data including one, eight bit-per-layer pixel 502. The pixel 502 defines an image resolution of 600-by-600 dots per inch. Also, the pixel 502 is defined by a cyan color layer 504, a magenta color layer 506, and a yellow color layer 508. Thus, the pixel 502 is substantially equivalent to the pixel 30 of FIG. 1.

As further depicted in FIG. 6, each of the color layers 504-508 is respectively defined by a total of eight data bits. As further depicted in FIG. 6, the cyan color layer 504 is considered to have an exemplary cyan color layer intensity of 82.8%. Similarly, the magenta color layer 506 is considered to define a color intensity of 16.4%, while the yellow color layer 508 is considered to define a value of 56.6% color intensity. When suitably rendered (e.g., inkjet, display screen, etc.), each of the color layers 504-508 chromatically combine such that the pixel 502 includes substantially one perceptible color or hue.

In one embodiment of the exemplary method 500, the definition (intensity value) of each color layer 504-508 of the pixel 502 is respectively compared to a set of predefined color layer 504-508 definition ranges, each of which corresponds to a predefined threshold value. Each successive threshold value is one-eighth greater in value than the prior threshold value. Thus, such a set of threshold values can be defined as zero, one-eighth, two-eighths, three-eighths, etc., up to and including eight-eighths (or unity). Furthermore, each threshold value corresponds to a predetermined number of active or “on” data bits. Table 1 below summarizes the color layer definition, threshold value, and active data bits correspondence, as depicted in FIG. 6.

TABLE 1

| COLOR LAYER DEFINITION | THRESHOLD | ACTIVE BITS |
|---|---|---|
| 0-12.4× % | 0 | 0 |
| 12.5-24.9× % | 1/8 | 1 |
| 25.0-37.4× % | 2/8 | 2 |
| 37.5-49.9× % | 3/8 | 3 |
| 50.0-62.4× % | 4/8 | 4 |
| 62.5-74.9× % | 5/8 | 5 |
| 75.0-87.4× % | 6/8 | 6 |
| 87.5-99.9× % | 7/8 | 7 |
| 100% | 1 | 8 |

Therefore, translation of image data by way of the exemplary method 500 as depicted in FIG. 6 is performed as follows: the definition of the cyan color layer 504 of pixel 502, 82.8%, is compared with the COLOR LAYER DEFINITION ranges provided Table 1. Therein, it is determined that 82.8% falls with the defined range of 75.0-87.4X%, corresponding to a THRESHOLD of 6/8 and an ACTIVE BITS count of six (6). Applying this same method to color layers 506 and 508 results in corresponding ACTIVE BITS counts of one (1) and four (4), respectively.

Next, the active bit counts of six, one and four for the color layers 504-508 (respectively) found by way of Table 1 above are used to define like numbers of active data bits within three respective translated (i.e., approximated) color layers. As depicted in FIG. 6, a translated cyan color layer 544 is defined including a total of six (6) active (i.e., “one”) data bits 514. In turn, a translated magenta color layer 546 and a translated yellow color layer 548 are also defined, including one (1) active data bit 516 and four (4) active data bits 518, respectively. As each of the translated color layers 544-548 is respectively defined by eight total data bits 524-528 respectively, those data bits 524-528 not already defined as active data bits 514-518 are defined by inactive or “zero” data bits. The translated color layers 544-548 collectively define a total of eight, one bit-per-layer translated pixels 542.

Each of the translated pixels 542 defines an image resolution of 2400-by-1200 dots per inch, wherein the eight translated pixels 542 are mutually arranged to define an overall image region 540, which in turn defines an image resolution of 600-by-600 dots per inch. It is to be understood that the when the translated color layers 544-548 are rendered, or imaged, by way of, for example, an inkjet printer, an electronic display screen, or other suitable apparatus, each of the eight translated pixels 542 represents a single, chromatically combined color or hue. Furthermore, the eight translated pixels 542 of the image region 540 are defined by one, twenty-four bit data word. In this way, the translation method 500, as depicted in FIG. 6, generally results in an eight-fold increase in image resolution relative to the original eight bit-per-layer pixel 502.

The exemplary method 500, as depicted in FIG. 6, can be used to provide a desirable increase in image resolution when translating a pixel 502 that defines, or represents, the edgewise or perimeter portion of a graphical object in a image data file. The exemplary method 500 can also be applied to other types of image data, as desired. In another embodiment of the method 500 (not shown), the threshold values and/or other correspondences (i.e., as provided in Table 1 above) can be substantially redefined as desired or required. Other translation methodologies can also be used within the teachings of the present invention, which respectively result in the translation of one, eight bit-per-layer pixel into, eight, one bit-per-layer pixels of the same (or different) respective image resolutions as the pixels 502 and 542 of FIG. 6.

FIG. 6A is a block schematic view, depicting an imaging arrangement 550 in accordance with the method 500 of FIG. 6. The imaging arrangement 550 includes an image window 552. The image window 552 includes a three-by-three, mixed-resolution arrangement, including a total of six high-resolution image regions 558, and a total of three low-resolution image regions 556. Therein, each high-resolution image region 558 is defined by a total of eight, one bit-per-layer pixels (not shown in FIG. 6A, see the pixels 402 of FIG. 5). Also, each low-resolution image region 556 is defined by a single, eight bit-per-layer pixel (not shown in FIG. 6A, see the pixels 310 of FIG. 4).

Next, it is assumed that the exemplary method 500 of FIG. 6, substantially as described above, is applied to the pixels (not shown) of the three low-resolution image regions 556 of the image window 552. As a result, a translated image window 554 is defined. The translated image window 554 includes a total of three image regions 560 in direct correspondence to the three low-resolution image regions 556 of the image window 552. Also, the translated image window includes the six high-resolution image regions 558, as originally present in the image window 552. Each of the image regions 560 of the translated image window 554 includes eight, respectively defined, translated one bit-per-layer pixels that are substantially equal to the translated pixels 542 of FIG. 6. To clarify, the image window 554 is defined to include a twelve-by-six arrangement of translated pixels 542.

Thus, both the image window 552, and the translated image window 554, can be respectively defined by nine, twenty-four bit data words. That is, equal quantities of data can be used to define each of the image window 552 and the translated image window 554. However, as a result of the method 500 of FIG. 6, the translated image window 554 comprises nine equal-resolution image regions, wherein each region is comprised of eight 2400-by-1200 dots per inch pixels within an area equal in resolution to one 600-by-600 dots per inch pixel. This is compared to the mixed-resolution image regions 556 and 558 of the image window 552. This sort of image data translation can be desirable, for example, to enable the rendering of images on imaging apparatus (e.g., printers, electronic displays, etc.) that otherwise cannot readily, if at all, handle the kind of mixed-resolution image data that defines the image window 552. As a further example, some imaging apparatuses can only operate with image data configured to represent one bit-per-layer pixels. The image data translation of the exemplary method 500 of FIG. 6 (or another suitable embodiment thereof, not shown) can be suitably used with such imaging apparatuses.

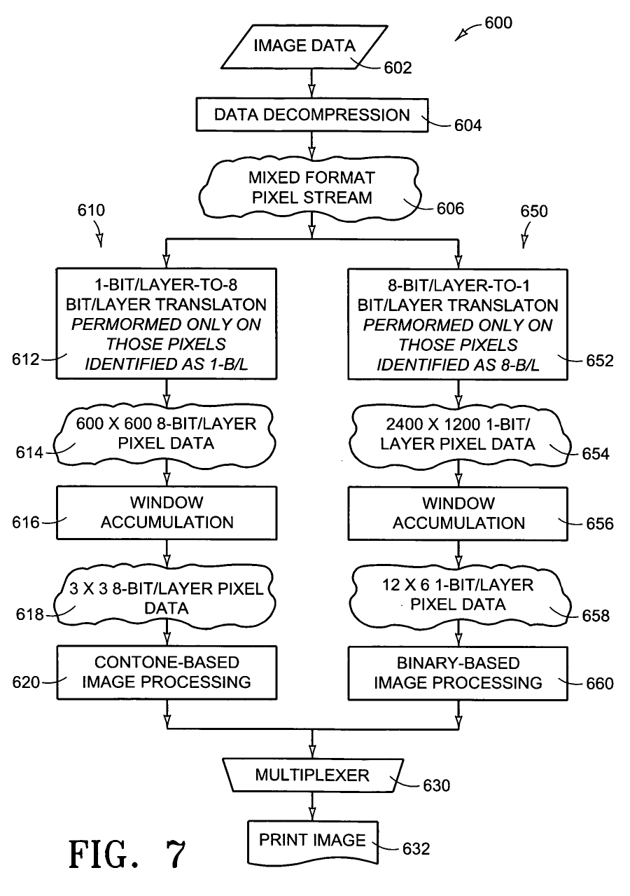

FIG. 7 is a flowchart 600, depicting still another exemplary method in accordance with embodiments of the present invention. While the method as depicted by flowchart 600 includes particular method steps and order of execution, it is to be understood that other methods (not shown) can also be used, including other steps and/or other orders of execution, all in accordance with embodiments of the present invention.

To begin, it is assumed that an image data file 602 is provided. Such an image data file can include, for example, TIFF image data, bitmap image data, JPEG image data, or any other image data format that is suitable for use with the methods of the present invention. For purposes of example, it is assumed that the image data file 602 includes bitmap-formatted data defining a graphical image, wherein the image data file includes both relatively high and low resolution image data. Thus, the image data file 602 is assumed to define both one bit-per-layer pixels (e.g., pixels 402 of FIG. 5), and eight bit-per-layer pixels (e.g., pixel 502 of FIG. 6) as desired during the creation process of the image.

In step 604, a suitable data decompression technique is selectively applied to the image data file 602. In this way, a mixed-format image data stream 606 is provided, wherein the image data stream 606 can be selectively routed to either or both of two different processing paths 610 and 650, as described hereinafter. For purposes of ongoing example, it is assumed that the image data stream 606 is routed to the processing path 610.

In step 612, the image data stream 606 is examined to identify any one bit-per-layer pixels (e.g., pixels 402 of FIG. 5) defined therein. The identity of such one bit-per-layer pixels can be performed, for example, in accordance with respective indicator bits or “flags” that are logically associated with the particular pixels. Such suitably identified data within the image data stream 606 are translated, as associated arrangements of eight, one bit-per-layer pixels, so as to define a single translated eight bit-per-layer pixel (e.g., the pixel 440 of FIG. 5). Thus, step 612 of FIG. 7 is substantially directed to performing the method 400 of FIG. 5, as described above. Furthermore, any data within the image data stream 606 originally defining an eight bit-per-layer pixel is left unchanged in step 612. As a result, an eight bit-per-layer pixel data stream 614 is provided by step 612. Thus, step 612 is generally directed to the translation, or synthesis, of relatively low-resolution image data.

In step 616, the eight bit-per-layer data stream 614 is selectively gathered so as to define respective image windows (not shown in FIG. 7), each including a three-by-three arrangement of eight bit-per-layer pixels, substantially as described above in regard to the image window 454 of FIG. 5A. As further depicted in FIG. 7, the result of step 616 is the issuance of one or more image windows as a data stream 618.

In step 620, one or more image processing techniques are selectively applied to the image window data stream 618. As depicted in FIG. 7, such techniques are generally referred to as continuous tone (i.e., contone) based image processing techniques. One of skill in the imaging arts is aware of numerous such processing techniques, and further elaboration is not required. In any case, the typically result of step 620 is image data defining a plurality of eight bit-per-layer pixels that are ready for imaging.

In step 630, a multiplexer step combines image data from processing paths 610 and 650 (described hereafter), so as define a single data stream for imaging in the next step 632 of the flowchart 600. In the interest of ongoing example, it is assumed that the multiplexer of step 630 simply passes the image data from step 620 above to step 632 described hereinafter. In one embodiment, steps 604-620 are repeatedly (iteratively) executed such that the pixels of the image data 602 are processed in a sort of scanned or “rasterized” manner thus producing a sequence of three-by-three image windows 618. In such an embodiment, the multiplexer 630 selects the center pixel (not shown, see the center pixel 460 in FIG. 5A) only from each such image window 618 processed in step 620 and passes it along to imaging step 632. In this way, for example, a pixel (not shown) which is a center pixel (i.e., selected by the multiplexer 630) of an image window 618 in a given iteration of the process of the flowchart 600, is then a peripheral or edgewise pixel (i.e., ignored by the multiplexer 630) of an image window 618 in a subsequent iteration of the process of the flowchart 600. Other pixel (i.e., image data) selection strategies can also be used by the multiplexer 630.

In step 632, the image data stream from the multiplexer step 630 is rendered (i.e., imaged) by a suitable apparatus such as, for example, an inkjet printer. While step 632, as depicted in FIG. 7, depicts printing an image, it is to be understood that the image data stream from step 630 can also be rendered by way of an electronic display screen, routed and saved to computer-readable storage media, etc.

The steps 604 through 632 are assumed to be performed in a generally sequential, continuous stream manner until the entire image data file 602 has been processed and imaged by the printer at step 632. Once the entire image data file 602 has been so processed, the method of the path 610 is considered complete for a single operation.

Next, the typical operation of the process path 650 will be considered. To begin, it is again assumed that an image data file 602 has been provided, and that any suitable or required decompression step 604 has been performed, substantially as described above, resulting in another mixed-format image data stream 606.

In step 652, the image data stream 606 is examined to identify any eight bit-per-layer pixels (e.g., pixels 502 of FIG. 6) defined therein. Such suitably identified data (e.g., flagged, etc.) within the image data stream 606 are translated so as to define respective, associated image regions including eight, translated one bit-per-layer pixels (e.g., the pixels 542 of FIG. 6). Thus, step 652 of FIG. 7 is substantially directed to performing the method 500 of FIG. 6 as described above. Furthermore, any data within the image data stream 606 originally defining a one bit-per-layer pixel is left unchanged (i.e., ignored) in step 652. As a result, a one bit-per-layer pixel data stream 654 is provided by step 652. In this way, step 650 is generally directed to the translation, or synthesis, of relatively high-resolution image data.

In step 656, the one bit-per-layer data stream 654 is selectively gathered so as to define respective image windows (not shown in FIG. 7), each including a twelve-by-six arrangement of one bit-per-layer pixels, substantially as described above in regard to the image window 554 of FIG. 6A. As further depicted in FIG. 7, the result of step 656 is the issuance of one or more image windows as a data stream 658.

In step 660, one or more image processing techniques are selectively applied to the image window data stream 658. As depicted in FIG. 7, such techniques are generally referred to as binary-based image processing techniques. The typical result of step 660 is image data defining a plurality of one bit-per-layer pixels that are ready for imaging or other use.

Thereafter, in step 630, the multiplexer step described above combines image data from processing paths 610 and 650, if both paths are actively operating, so as to define a single data stream for imaging in the next step 632. In the example of processing path 650, it is assumed that the multiplexer of step 630 simply receives and passes through the image data from step 660 above. In one embodiment, the multiplexer 630 selects the centralized eight pixels (not shown, see the centralized image region 558 of FIG. 6A) only and passes those along to the imaging step 632. Other pixel (image data) selection strategies can also be used by the multiplexer 630.

In step 632, the image data stream from the multiplexer step 630 is rendered (i.e., imaged) by a suitable apparatus substantially as described above. Alternatively, the data stream from step 630 can be rendered by way of an electronic display screen, routed and saved to computer-readable storage media, etc.

As the exemplary method of flowchart 600 was described above, separate consideration was given to the processing paths 610 and 650. It is to be understood that in another operative instance, both of the processing paths 610 and 650 can be performed in a substantially simultaneous manner, such that respective data streams from steps 620 and 660 are selected (e.g., center pixel-by-center pixel, etc.) at multiplexer step 630 for imaging (rendering) in step 632.

Any of the data imaging arrangements and exemplary methods 400, 500 and 600, as respectively described above, can be implemented and/or performed by way of a suitable computer system, dedicated electronic devices, etc. (not shown). Furthermore, the teachings of the present invention can be implemented by way of suitable processor-executable program code provided by way of computer-readable storage media, such as, for example, CD-ROM, non-volatile solid-state memory, magnetic tape or disk, etc. (not shown).

In view of the descriptions and teachings respectively provided above, one of skill in the imaging arts can now appreciate the following characteristics, applications and benefits of various embodiments of the present invention:

1) Various embodiments of the present invention can be used to construct image files that have 2 or more differing image resolutions defined within them, without redundant specifications (i.e., definitions) for any given pixel and without distorting the regular form of the stored image in memory. This aspect provides for predictable access to any location of the image in memory (or other storage media) and is generally desirable during image creation and processing.

2) Differing embodiments of the present invention provide for the processing of image data using one or more known techniques, in conjunction with other inventive methods as presented herein. Thus, known techniques can be used with methods and/or apparatus of the present invention while taking advantage of various benefits thereof.

3) Suitable embodiments of the present invention permit the printing (rendering) of pixels while taking advantage of the resolution and/or color depth originally inherent thereto, while also providing a uniform resolution “context” within an image window or region through the use of translated pixels. Generally, this window context is directed to selective or best processing (i.e., translation) of surrounding pixels with respect to the center pixel of a selected window (e.g., with respect to the center region 558 of the image window 554 of FIG. 6A). Thus, for example, the multiplexer step 630 (of the flowchart 600 of FIG. 7) can be configured to select only untranslated center pixels from image data streams 618 and/or 658 for imaging or rendering in step 632, as it may be undesirable under some situations to render (print) translated pixels which define the center of an image region or window.

4) While the methods and apparatus of the present invention have been described with respect to image windows or regions of a three-by-three pixel configuration, it is to be understood that other window configurations defined by different X-by-Y dimensions can also be used. For example, an embodiment of the present invention can be defined and used wherein image windows are defined by respective nine-by-nine arrangements of pixels. Other image regions can also be defined and used.

5) The methods and apparatus of the present invention were generally described and exemplified above in the context of cyan-magenta-yellow (i.e., CMY) type image data. It is to be understood that suitable embodiment of the present invention can also be used with data defining other image types including, but not limited to, CMYK, RGB, monochrome, etc.

While the above methods and apparatus have been described in language more or less specific as to structural and methodical features, it is to be understood, however, that they are not limited to the specific features shown and described, since the means herein disclosed comprise preferred forms of putting the invention into effect. The methods and apparatus are, therefore, claimed in any of their forms or modifications within the proper scope of the appended claims appropriately interpreted in accordance with the doctrine of equivalents.

What is claimed is:

1. A method, comprising:
providing image data defining a plurality of pixels, each pixel defined by one or more color layers, each color layer defined by one or more data bits;
selecting two or more of the plurality of pixels;
translating the one or more data bits defining each of the one or more color layers of the two or more selected pixels in accordance with a predefined function to define a single translated pixel; and
rendering an image including the single translated pixel.

2. The method of claim 1, wherein the translating in accordance with the predefined function includes averaging the one or more data bits defining each of the one or more color layers of the two or more selected pixels.

3. The method of claim 1, wherein the translating in accordance with the predefined function includes summing the one or more data bits defining each of the one or more color layers of the two or more selected pixels.

4. The method of claim 1, wherein the two or more selected pixels collectively define an image resolution of 600-by-600 dots per inch.

5. The method of claim 1, wherein the single translated pixel defines an image resolution of 600-by-600 dots per inch.

6. The method of claim 1, wherein the one or more color layers of the two or more selected pixels are defined by a cyan color layer and a magenta color layer and a yellow color layer.

7. The method of claim 1, wherein:
the single translated pixel is defined by one or more translated color layers; and
each translated color layer is defined by a plurality of data bits.

8. The method of claim 7, wherein each of the one or more translated color layers is defined by eight data bits.

9. The method of claim 1, wherein providing the image data is further defined by providing image data defining a plurality of pixels of at least two different image resolutions.

10. The method of claim 1, wherein:
each of the plurality of pixels is defined by three color layers; and
each of the three color layers is defined by eight data bits.

11. The method of claim 1, wherein at least one of the two or more selected pixels defines a perimeter portion of a graphical object.

12. The method of claim 1, wherein the rendering an image is defined by rendering an image including the single translated pixel on one of a display screen, a sheet media, or a computer-readable media.

13. The method of claim 1, wherein the providing the image data defining a plurality of pixels is further defined as providing image data defining a plurality of pixels, each of the plurality of pixels defined by one of a CMYK, an RGB, or a monochrome image type.

14. A method, comprising:
providing image data defining a plurality of pixels, each pixel defined by one or more color layers, each color layer defined by a plurality of data bits;
selecting one of the plurality of pixels;
translating the plurality of data bits defining each of the one or more color layers of the selected pixel in accordance with a predefined function to define two or more translated pixels; and
rendering an image including the two or more translated pixels.

15. The method of claim 14, wherein the translating in accordance with a predefined function includes comparing the plurality of data bits defining each of the one or more color layers of the selected pixel with a single predefined threshold.

16. The method of claim 14, wherein the translating in accordance with a predefined function includes comparing the plurality of data bits defining each of the one or more color layers of the selected pixel with a predefined threshold corresponding to a particular one of the color layers.

17. The method of claim 14, wherein the selected pixel defines an image resolution of 600-by-600 dots per inch.

18. The method of claim 14, wherein the two or more translated pixels collectively define an image resolution of 600-by-600 dots per inch.

19. The method of claim 14, wherein each of the translated pixels defines an image resolution of 2400-by-1200 dots per inch.

20. The method of claim 14, wherein the one or more color layers of the selected pixel are defined by a cyan color layer and a magenta color layer and a yellow color layer.

21. The method of claim 14, wherein:
each of the two or more translated pixels is defined by two or more translated color layers; and
each of the translated color layers is defined by one or more data bits.

22. The method of claim 14, wherein the providing the data is further defined by providing data defining a plurality of pixels of at least two different image resolutions.

23. The method of claim 14, wherein:
each of the plurality of pixels is defined by three color layers; and
each of the three color layers is defined by eight data bits.
The second method described first above, wherein at least one of the two or more translated pixels defines a perimeter portion of a graphical object.

24. The method of claim 14, wherein the rendering an image is defined by rendering an image including the two or more translated pixels on one of a display screen, a sheet media, or a computer-readable media.

25. A method of handling image data, comprising:
providing image data defining a plurality of pixels, each pixel defining one of a first resolution or a second resolution;
selectively translating one or more pixels of the first resolution of the image data to define a first number of translated pixels of the second resolution, the first number of translated pixels collectively defining a first type image window;
selectively translating one or more pixels of the second resolution of the image data to define a second number of translated pixels of the first resolution, the second number of translated pixels collectively defining a second type image window;
combining the image windows of the first type and the second type to define translated image data; and
rendering an image including the translated image data.

26. The method of handling image data of claim 25, and further comprising decompressing the image data prior to the selectively translating the one or more pixels of the first resolution and the selectively translating the one or more pixels of the second resolution and the combining the image windows of the first type and second type.

27. The method of handling image data of claim 25, and further comprising selectively processing the translated pixels of the first resolution in accordance with a predefined function prior to the combining the image windows of the first type and the second type.

28. The method of handling image data of claim 27, wherein the predefined function is defined by a contone pixel-type function.

29. The method of handling image data of claim 25, and further comprising selectively processing the translated pixels of the second resolution in accordance with a predefined function prior to the combining the image windows of the first type and the second type.

30. The method of handling image data of claim 29, wherein the predefined function is defined by a binary-type function.

31. The method of handling image data of claim 25, wherein the rendering an image is defined by rendering an image including the translated image data on one of a display screen, a sheet media, or a computer-readable media.

32. The method of handling image data of claim 25, wherein each of the pixels of the first resolution defines an image resolution of 2400-by-1200 dots per inch.

33. The method of handling image data of claim 25, wherein each of the pixels of the second resolution defines an image resolution of 600-by-600 dots per inch.

34. The method of handling image data of claim 25, wherein the first type image window is further defined by a three-by-three arrangement of the translated pixels of the second resolution.

35. The method of handling image data of claim 25, wherein the second type image window is further defined by a twelve-by-six arrangement of the translated pixels of the first resolution.

36. The method of handling image data of claim 25, wherein
each of the plurality of pixels is defined by one or more color layers; and
each of the color layers is defined by one or more data bits.

37. The method of handling image data of claim 25, wherein one or more of the translated pixels of the first resolution or one or more of the translated pixels of the second resolution define a perimeter portion of a graphical object.

38. A computer-readable storage media including a program code, the program code configured to cause a processor to:
select data defining two or more pixels from data defining a plurality of pixels, each pixel defined by one or more color layers, each color layer defined by one or more data bits; and
translate the one or more data bits defining each of the one or more color layers of the data of the two or more selected pixels in accordance with a predefined function to derive data defining a single translated pixel.

39. The computer-readable storage media of claim 38, wherein the program code is further configured to cause the processor to average the one or more data bits of each color layer of the data of the two or more selected pixels.

40. The computer-readable storage media of claim 38, wherein the program code is further configured to cause the processor to sum the one or more data bits of each color layer of the data of the two or more selected pixels.

41. The computer-readable storage media of claim 38, wherein the program code is further configured such that the single translated pixel defines an image resolution of 600-by-600 dots per inch.

42. A computer-readable storage media including a program code, the program code configured to cause a processor to:
select data defining one pixel from a plurality of pixels, each pixel defined by one or more color layers, each color layer defined by a plurality of data bits; and
translate the plurality of data bits defining each of the one or more color layers of the selected pixel in accordance with a predefined function to derive data defining two or more translated pixels.

43. The computer-readable storage media of claim 42, wherein the program code is further configured to cause the processor to compare the plurality of data bits defining each color layer of the data of the selected pixel with a single predefined threshold.
The second computer-readable storage media described first above, wherein the program code is further configured to cause the processor to compare the plurality of data bits defining each color layer of the data of the selected pixel with a predefined threshold corresponding to a particular one of the one or more color layers.

44. The computer-readable storage media of claim 42, wherein the program code is further configured such that each of the two or more translated pixels defines an image resolution of 2400-by-1200 dots per inch.

45. A computer-readable storage media including a program code, the program code configured to cause a processor to:
receive image data defining a plurality of pixels, each pixel defining one of a first resolution or a second resolution;
selectively translate data defining two or more pixels of the first resolution of the image data to derive data defining a first number of translated pixels of the second resolution, the first number of translated pixels collectively defining a first type image window;
selectively translate data defining two or more pixels of the second resolution of the image data to derive data defining a second number of translated pixels of the first resolution, the second number of translated pixels collectively defining a second type image window; and
combine the data of the image windows of the first type and the second type to define translated image data.

46. The computer-readable storage media of claim 45, wherein the program code is further configured to cause the processor to decompress the image data prior to the selectively translating the one or more pixels of the first resolution and the selectively translating the one or more pixels of the second resolution and the combining the image windows of the first type and second type.

47. The computer-readable storage media of claim 45, wherein the program code is further configured to cause the processor to selectively process the translated pixels of the first resolution in accordance with a predefined function prior to the combining the image windows of the first type and the second type.
The third computer-readable storage media described immediately above, wherein the program code is further configured such that the predefined function is defined by a contone pixel-type function.

48. The computer-readable storage media of claim 45, wherein the program code is further configured to cause the processor to selectively process the translated pixels of the second resolution in accordance with a predefined function prior to the combining the image windows of the first type and the second type.

49. The computer-readable storage media of claim 48, wherein the program code is further configured such that the predefined function is defined by a binary-type function.

50. The computer-readable storage media of claim 45, wherein the program code is further configured to cause the processor to image the translated image data using an imaging apparatus.

51. A method, comprising:
providing image data defining one or more pixels, each pixel defined by one or more color layers, each color layer defined by two data bits; and
rendering an image including the one or more pixels.
The fourth method described immediately above, wherein:
each pixel is defined by a cyan color layer and a magenta color layer and a yellow color layer; and
each pixel defines an image resolution of 1200-by-1 200 dots per inch.

52. A method, comprising:
providing image data defining one or more pixels, each pixel defined by one or more color layers, each color layer defined by one data bit; and
rendering an image including the one or more pixels.

53. The method of claim 52, wherein:
each pixel is defined by a cyan color layer and a magenta color layer and a yellow color layer; and
each pixel defines an image resolution of 2400-by-1200 dots per inch.

54. A method, comprising:
providing image data defining a plurality of pixels, each pixel defining one of a first resolution or a second resolution;
arranging the image data to define an image window, wherein the image window includes a first number of pixels of the first resolution and a second number of pixels of the second resolution; and
rendering an image including the image window.

55. The method of claim 54, wherein:
each pixel of the first resolution defines an image resolution of 2400-by-1200 dots per inch; and
each pixel of the second resolution defines an image resolution of 600-by-600 dots per inch.

56. The method of claim 54, wherein:
the image window defines a three-by-three arrangement of image regions; and
each image region defines an image resolution of 600-by-600 dots per inch.
